(19) United States
(12) Patent Application Publication
(10) Pub. No.: US 2016/0268900 A1
(43) Pub. Date: Sep. 15, 2016

(54) POWER SUPPLY CIRCUIT AND CONTROL METHOD THEREOF

(71) Applicant: KABUSHIKI KAISHA TOSHIBA, Tokyo (JP)

(72) Inventor: Takayuki Miyazaki, Tokyo (JP)

(21) Appl. No.: 14/845,091

(22) Filed: Sep. 3, 2015

(30) Foreign Application Priority Data
Mar. 12, 2015 (JP) 2015-050028

(51) Int. Cl. H02M 3/158

(52) U.S. Cl. CPC H02M 3/158

(57) ABSTRACT

According to one embodiment, a power supply circuit comprises a high-side switch having a plurality of switching transistors connected in parallel and a low-side switch having a plurality of switching transistors connected in parallel. The circuit has a control circuit that causes the high-side switch and the low-side switch to alternately turn on/off. The control circuit causes the plurality of switching transistors forming the high-side switch and the low-side switch to turn on/off at different timings.

### CROSS-REFERENCE TO RELATED APPLICATIONS

This application is based upon and claims the benefit of priority from Japanese Patent Application No. 2015-50028, filed on Mar. 12, 2015; the entire contents of which are incorporated herein by reference.

### FIELD

Embodiments described herein relate generally to a power supply circuit and a control method thereof.

### BACKGROUND

In power supply circuits which have a high-side switch and a low-side switch, a so-called dead time is provided to prevent a shoot-through current that would occur if these switches turned on simultaneously. In order to reduce power consumption, it is desired that the dead time be short. Meanwhile, the polarity of the voltage occurring on a common connection terminal to which the high-side switch and the low-side switch are connected in common, varies depending on the on/off timings of the high-side switch and the low-side switch and the flow direction of inductor current. Thus, an overvoltage may be applied to switching transistors forming each switch depending on the direction of the inductor current. In order to protect the switching transistors against destruction due to the application of the overvoltage, it is desired to provide a power supply circuit excellent in the controllability of the dead time.

### BRIEF DESCRIPTION OF THE DRAWINGS

FIG. 1 is a diagram showing the configuration of a power supply circuit of a first embodiment;

FIG. 2 is a chart for explaining the control method of the power supply circuit of the first embodiment;

FIG. 3 is a diagram showing the configuration of an embodiment of a dead time producing circuit;

FIG. 4 is a chart for explaining the operation of the dead time producing circuit;

FIG. 5 is a diagram showing the configuration of a power supply circuit of a third embodiment;

FIG. 6 is a chart for explaining the control method of the power supply circuit of the third embodiment;

FIG. 7 is a diagram showing the configuration of a power supply circuit of a fourth embodiment;

FIG. 8 is a chart for explaining the control method of the power supply circuit of the fourth embodiment;

FIG. 9 is a diagram showing the configuration of a power supply circuit of a fifth embodiment; and

FIG. 10 is a chart for explaining the control method of the power supply circuit of the fifth embodiment.

### DETAILED DESCRIPTION

In general, according to one embodiment, a power supply circuit comprises a high-side power supply line to which to apply an input voltage, a common connection end to which one end of an inductive load is connected, an output end to which the other end of the inductive load is connected, and a low-side power supply line. The circuit has a high-side switch having a parallel connection of a plurality of switching transistors whose main current paths are connected between the high-side power supply line and the common connection end and a low-side switch having a parallel connection of a plurality of switching transistors whose main current paths are connected between the low-side power supply line and the common connection end. The circuit has a control circuit that causes the high-side switch and the low-side switch to alternately turn on/off. The control circuit causes the plurality of switching transistors forming the high-side switch to turn on/off at different timings and the plurality of switching transistors forming the low-side switch to turn on/off at different timings.

Exemplary embodiments of a power supply circuit and control method thereof will be explained below in detail with reference to the accompanying drawings. The present invention is not limited to the following embodiments.

### First Embodiment

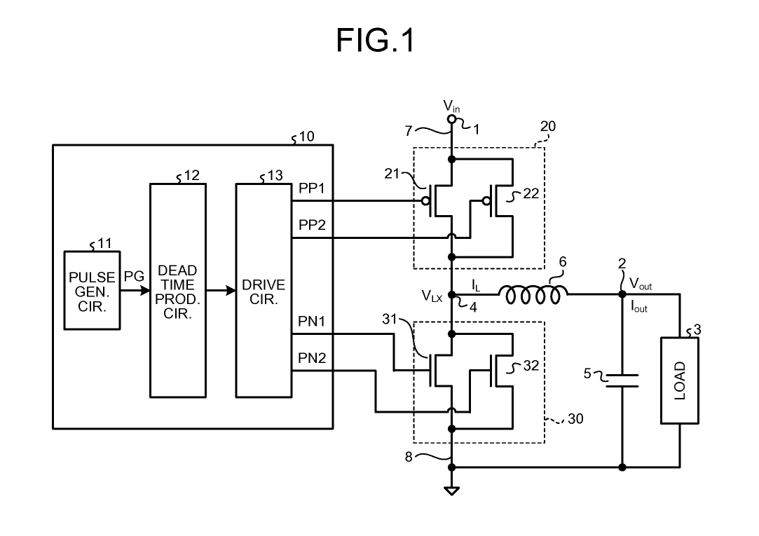

FIG. 1 is a diagram showing the configuration of a power supply circuit of the first embodiment. The power supply circuit of this embodiment has an input end 1 to which a direct-current input voltage Vin is applied. A high-side power supply line 7 is connected to the input end 1. The power supply circuit has a first high-side switching transistor 21 whose source is connected to the high-side power supply line 7. The drain of the first high-side switching transistor 21 is connected to a common connection end 4. The power supply circuit has a second high-side switching transistor 22 whose source is connected to the high-side power supply line 7. The drain of the second high-side switching transistor 22 is connected to the common connection end 4. The first and second high-side switching transistors 21, 22 form a high-side switch 20.

The first and second high-side switching transistors 21, 22 are constituted by PMOS transistors. The source-to-drain path of the PMOS transistor constitutes a main current path. For example, a PMOS transistor smaller in size than the second high-side switching transistor 22 is used as the first high-side switching transistor 21. A transistor smaller in size has a smaller gate capacitance and hence can be turned on/off at higher speed. By making the first high-side switching transistor 21 smaller in size than the second high-side switching transistor 22, the on/off control of the first high-side switching transistor 21 can be performed at higher speed than that of the second high-side switching transistor 22.

The drain of a first low-side switching transistor 31 is connected to the common connection end 4. The source of the first low-side switching transistor 31 is connected to a low-side power supply line 8. The low-side power supply line 8 is grounded. The drain of a second low-side switching transistor 32 is connected to the common connection end 4. The source of the second low-side switching transistor 32 is connected to the low-side power supply line 8. The first and second low-side switching transistors 31, 32 form a low-side switch 30.

The first and second low-side switching transistors 31, 32 are constituted by NMOS transistors. The source-to-drain path of the NMOS transistor constitutes a main current path. For example, an NMOS transistor smaller in size than the second low-side switching transistor 32 is used as the first low-side switching transistor 31. By making the first low-side switching transistor 31 smaller in size than the second low-side switching transistor 32, the on/off control of the first low-side switching transistor 31 can be performed at higher speed than that of the second low-side switching transistor 32.

One end of an inductor 6 is connected to the common connection end 4. The other end of the inductor 6 is connected to an output end 2. One end of a smoothing capacitor 5 is connected to the output end 2. The other end of the smoothing capacitor 5 is grounded. A load 3 is connected to the output end 2.

The present embodiment has a drive control circuit 10. The drive control circuit 10 has a pulse generating circuit 11. The pulse generating circuit 11 outputs a pulse signal PG. In the case of PWM control, the pulse signal PG is a pulse-width modulated PWM signal. In the case of PFM control, the pulse signal PG is a pulse signal having a constant pulse width.

The pulse signal PG is supplied to a dead time producing circuit 12. The dead time producing circuit 12 produces predetermined dead times so that the high-side switch 20 and the low-side switch 30 are not on simultaneously and supplies drive signals to a drive circuit 13. The drive circuit 13 amplifies the drive signals from the dead time producing circuit 12 to supply drive signals (PP1, PP2, PN1, PN2) respectively to the gates of the high-side switching transistors (21, 22) forming the high-side switch 20 and the low-side switching transistors (31, 32) forming the low-side switch 30.

The first drive signal PP1 from the drive circuit 13 is supplied to the gate of the first high-side switching transistor 21. The second drive signal PP2 is supplied to the gate of the second high-side switching transistor 22. The first drive signal PN1 for the low-side switch 30 from the drive circuit 13 is supplied to the gate of the first low-side switching transistor 31. The second drive signal PN2 is supplied to the gate of the second low-side switching transistor 32.

In the present embodiment, the high-side switch 20 is constituted by a parallel connection of the two high-side switching transistors (21, 22) different in size. Likewise, the low-side switch 30 is constituted by a parallel connection of the two low-side switching transistors (31, 32) different in size. The individual drive signals (PP1, PP2, PN1, PN2) are supplied to the switching transistors (21, 22, 31, 32) respectively. Thus, the switching on/off of the switching transistors (21, 22, 31, 32) can be controlled individually, so that the controllability of the dead times is improved.

For example, the drive signal PP1 of the drive signals (PP1, PP2) supplied to turn on the high-side switching transistors (21, 22), which is supplied earlier than the other, is supplied to the high-side switching transistor 21 of a smaller size. By supplying the drive signal PP1, which is supplied earlier than the other, to the high-side switching transistor 21 of a smaller size, the switching on/off of the high-side switch 20 can be controlled at high speed, and thus the controllability of the high-side switch 20 is improved.

Likewise, the drive signal PN1 of the drive signals (PN1, PN2) supplied to turn on the low-side switching transistors (31, 32) on the low-side switch 30 side, which is supplied earlier than the other, is supplied to the gate of the low-side switching transistor 31 of a smaller size. By supplying the drive signal PN1, which is supplied earlier than the other, to the low-side switching transistor 31 of a smaller size, the switching on/off of the low-side switch 30 can be controlled at high speed, and thus the controllability of the low-side switch 30 is improved. By making the sizes of the switching transistors (21, 22, 31, 32) forming the high-side switch 20 and the low-side switch 30 different and supplying drive signals to the switching transistor (21, 31) of a smaller size earlier than to the others, the control of the dead times becomes easier.

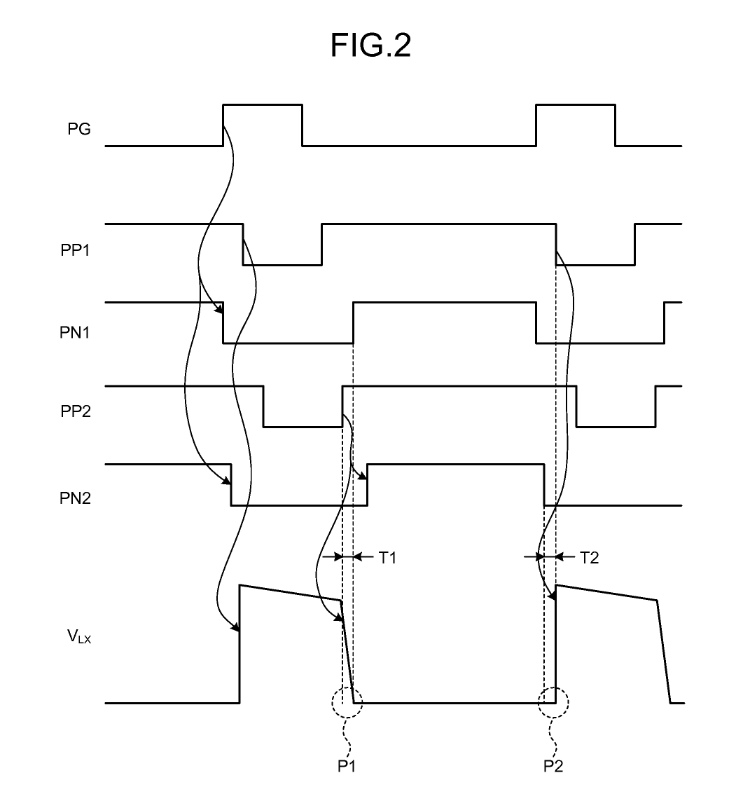

FIG. 2 is a chart for explaining the control method of the power supply circuit of the first embodiment. The pulse signal PG is supplied from the pulse generating circuit 11 to the dead time producing circuit 12. Predetermined dead times are set in the dead time producing circuit 12, and the drive signals (PP1, PP2, PN1, PN2) are outputted from the drive circuit 13. The drive signal PP1, which is outputted from the drive circuit 13 earlier than the other, is supplied to the gate of the high-side switching transistor 21. Since being constituted by a PMOS transistor of a smaller size, the high-side switching transistor 21 responds to the drive signal PP1 at higher speed. The drive signal PP2 is supplied to the gate of the high-side switching transistor 22.

The drive signal PN1, which is outputted from the drive circuit 13 earlier than the other, is supplied to the gate of the low-side switching transistor 31. Since being constituted by an NMOS transistor of a smaller size, the low-side switching transistor 31 responds to the drive signal PN1 at higher speed. The drive signal PN2 is supplied to the gate of the low-side switching transistor 32.

When the high-side switching transistor 21 turns on, the voltage V_{LX} on the common connection end 4 rises. That is, the timing of the switching on of the high-side switching transistor 21 determines the timing of the rise of the voltage V_{LX} on the common connection end 4. The timing of the switching on of the high-side switching transistor 21 is set by the drive signal PP1, which is supplied from the drive circuit 13 earlier than the other.

The fall of the voltage V_{LX} on the common connection end 4 is determined by the timing of the switching off of the high-side switching transistor 22. The time T1 from the switching off of the high-side switching transistor 22 to the switching on of the low-side switching transistor 32 is a first dead time.

The time T2 from the switching off of the low-side switching transistor 32 to the switching on of the high-side switching transistor 21 is a second dead time. The timing of the switching off of the low-side switching transistor 32 is determined by the timing of the fall of the drive signal PN2. The timing of the switching on of the high-side switching transistor 21 is determined by the timing of the fall of the drive signal PP1. The generation timings of the drive signals are produced by the dead time producing circuit 12. The configuration of the dead time producing circuit 12 will be described later.

In the dead times T1 and T2, if an inductor current I_{L} flows toward the inductor 6 side, the voltage V_{LX} on the common connection end 4 becomes negative in order to maintain the inductor current I_{L}. The gradient of the voltage V_{LX} is determined by the speed of charge/discharge by the inductor current I_{L}. Thus, by controlling the dead time T2 to be shorter, the high-side switch 20 can be controlled to turn on while a swing toward the negative voltage side of the voltage V_{LX} in the range indicated by a dotted line P2 corresponding to the dead time T2 is small. That is, by configuring such that the drive signal PP1 is supplied from the drive circuit 13 to the high-side switching transistor 21 of a smaller size earlier than the other, the dead time T2 can be made shorter. By making the delay time from the timing when the drive signal PN2 supplied to the low-side switching transistor 32 becomes a low level to when the drive signal PP1 supplied to the high-side switching transistor 21 becomes the low level be shorter, the dead time T2 can be made shorter.

The dead time T1 from the timing of the switching off of the high-side switching transistor 22 to the switching on of the low-side switching transistor 31 starts at the timing when the drive signal PP2 supplied to the high-side switching transistor 22 rises to a high level and is determined by the time until the drive signal PN1 of the high level is supplied to the low-side switching transistor 31. By making the delay time from the timing when the drive signal PP2 of the high level starts being supplied to the high-side switching transistor 22 to when the drive signal PN1 of the high level starts being supplied to the low-side switching transistor 31 be shorter, the dead time T1 can be made shorter.

In the dead time T1, if the inductor current I_{L} flows toward the inductor 6 side, the voltage V_{LX} on the common connection end 4 becomes a negative voltage in order to maintain the inductor current I_{L}. The dead time T1 from when the high-side switch 20 switches from on to off until the low-side switching transistor 31 of the low-side switch 30 is turned on is permitted to be equal to the time that the voltage V_{LX} on the common connection end 4 takes to change from the high level to a negative voltage. Thus, the dead time T1 can be set longer than the dead time T2. By turning on the low-side switch 30 before the voltage V_{LX} on the common connection end 4 becomes a negative voltage, the voltage V_{LX} in the range indicated by a dotted line P1 corresponding to the dead time T1 becoming a negative voltage can be avoided.

For example, it is assumed that, in the dead time T2, the voltage V_{LX} on the common connection end 4 decreases to a negative voltage limited by the forward voltage Vf of the parasitic diodes (not shown) of the low-side switching transistors and that likewise, in the dead time T1, the voltage V_{LX} decreases to a negative voltage limited by the forward voltage Vf of the parasitic diodes (not shown) of the low-side switching transistors. Letting the voltage V_{LX} be at a voltage VDD when the high-side switch 20 is on, the dead time T1 is permitted to be equal to the time that the voltage V_{LX} takes to decrease from the voltage VDD to the negative voltage Vf, and hence the dead time T1 can be set to be (VDD+Vf)/Vf times longer than the dead time T2. Since the dead time T1 can be set longer, the degrees of freedom in designing the power supply circuit are increased. By controlling the low-side switching transistor 31 to turn on before the voltage V_{LX} on the common connection end 4 becomes a negative voltage, the voltage V_{LX} on the common connection end 4 becoming a negative voltage can be avoided.

In the control method of the power supply circuit of the present embodiment, the power supply circuit can be configured such that the drive signals which are supplied earlier than the others from among the drive signals supplied from the drive circuit 13, are supplied to the switching transistors (21, 31) of smaller sizes from among the switching transistors (21, 22, 31, 32) connected in parallel of the high-side switch 20 and the low-side switch 30. Since the transistors of smaller sizes turn on/off at higher speed, the power supply circuit excellent in the controllability of the dead times can be provided.

### Second Embodiment

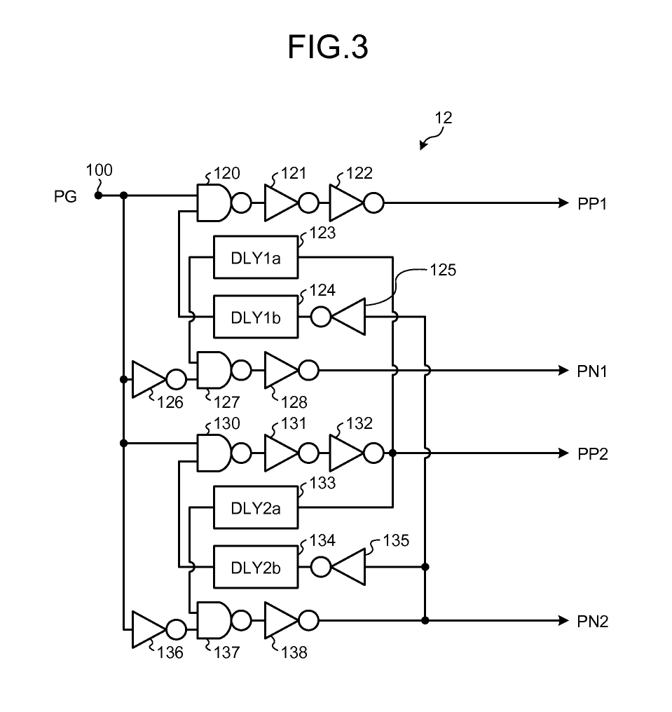

FIG. 3 is a diagram showing an embodiment of the dead time producing circuit 12. The dead time producing circuit 12 has an input end 100 to receive the pulse signal PG from the pulse generating circuit 11. The input end 100 is connected to one input end of a NAND circuit 120. A signal from a delay circuit 124 is inputted to the other end of the NAND circuit 120. The output signal of the NAND circuit 120 is outputted as the drive signal PP1, which is supplied to the high-side switching transistor 21, via two stages of inverters (121, 122).

The pulse signal PG is supplied to an inverter 126. The output of the inverter 126 is connected to one input end of a NAND circuit 127. A signal from a delay circuit 123 is inputted to the other input end of the NAND circuit 127. The output of the NAND circuit 127 is outputted as the drive signal PN1, which is supplied to the low-side switching transistor 31, via an inverter 128.

The pulse signal PG is inputted to one input end of a NAND circuit 130. A signal from a delay circuit 134 is inputted to the other end of the NAND circuit 130. The output signal of the NAND circuit 130 is outputted as the drive signal PP2, which is supplied to the high-side switching transistor 22, via two stages of inverters (131, 132). The output signal of the NAND circuit 132 is supplied to the delay circuit 123 and a delay circuit 133.

The pulse signal PG is supplied to an inverter 136. The output of the inverter 136 is connected to one input end of a NAND circuit 137. A signal from a delay circuit 133 is inputted to the other input end of the NAND circuit 137. The output of the NAND circuit 137 is outputted as the drive signal PN2, which is supplied to the low-side switching transistor 32, via an inverter 138. The output signal of the inverter 138 is supplied to the delay circuit 124 via an inverter 125 and to the delay circuit 134 via an inverter 135.

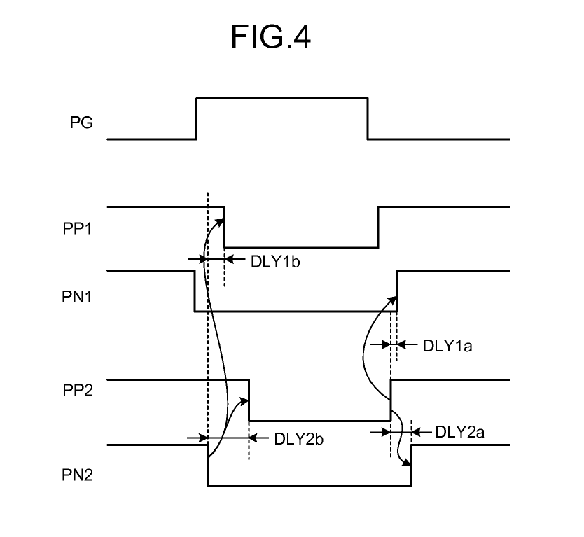

The operation of the dead time producing circuit 12 will be described using FIG. 4. In response to the rise of the pulse signal PG, the drive signals PN1 and PN2 fall. The drive signal PP1 falls after the time set by the delay time DLY1b of the delay circuit 124 has elapsed since the fall of the drive signal PN2. Likewise, the drive signal PP2 falls after the time set by the delay time DLY2b of the delay circuit 134 has elapsed since the fall of the drive signal PN2. Thus, by adjusting the delay time DLY1b of the delay circuit 124, the dead time T2 can be controlled.

Likewise, the drive signal PN1 rises after the time set by the delay time DLY1a of the delay circuit 123 has elapsed since the rise of the drive signal PP2, and the drive signal PN2 rises after the time set by the delay time DLY2a of the delay circuit 133 has elapsed since the rise of the drive signal PP2. Thus, by adjusting the delay time DLY1a of the delay circuit 123, the dead time T1 can be controlled. For example, where the delay circuits (123, 124, 133, 134) are each constituted by inverters (not shown), by configuring such that the number of stages of inverters can be selected, the power supply circuit can be configured such that the delay times of the delay circuits (123, 124, 133, 134) can be adjusted according to the operation state of the power supply circuit such as the flow direction of the inductor current I_{L}. By configuring such that, from among the inverters constituting each delay circuit (123, 124, 133, 134), the inverter of which stage to supply the input signal to can be selected, the delay times can be adjusted.

### Third Embodiment

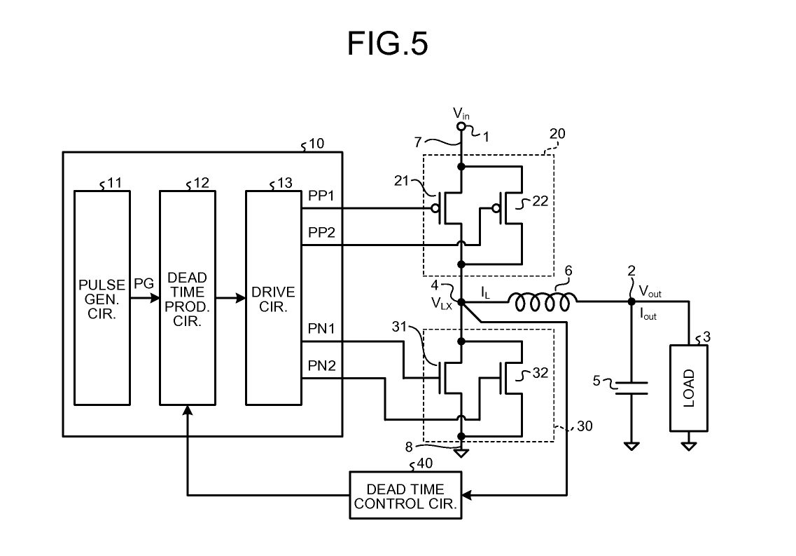

FIG. 5 is a diagram showing the configuration of a power supply circuit of the third embodiment. The same reference numerals are used to denote constituents corresponding to those of the already-described embodiments. The power supply circuit of the present embodiment has a dead time control circuit 40 that detects the voltage V_{LX} on the common connection end 4 to adjust dead times. The dead time control circuit 40 has a comparator (not shown) that compares, e.g., the voltage V_{LX} on the common connection end 4 with a predetermined reference voltage such as ground potential VSS. When the inductor current I_{L} is flowing toward the inductor 6 side, if the low-side switching transistors (31, 32) turn off, the voltage V_{LX} on the common connection end 4 becomes a negative voltage. Hence, in the present embodiment, by detecting the voltage V_{LX} on the common connection end 4 at the timing when the switching transistors (31, 32) of the low-side switch 30 turn off, control to adjust dead times is performed.

The control method of the power supply circuit of the third embodiment will be described using FIG. 6. FIG. 6 shows a timing chart of the control method of the power supply circuit of the third embodiment. In response to the pulse signal PG, the drive signal PP for the high-side switch 20 side is generated. Although, as already described, the drive signals (PP1, PP2) are respectively individually supplied to the switching transistors (21, 22) of the high-side switch 20, they are indicated as one drive signal PP for convenience. Likewise, although the drive signals (PN1, PN2) are respectively individually supplied to the switching transistors (31, 32) of the low-side switch 30, they are indicated as one drive signal PN for convenience.

If detecting a point t0 when the direction of the inductor current I_{L} changes, the dead time control circuit 40 controls the drive signal PN supplied to the low-side switch 30 to fall at the timing when a predetermined time has elapsed so as to turn off the low-side switching transistors (31, 32) at a timing later than the timing t0 when the inductor current I_{L} becomes zero. That is, while the inductor current I_{L} is beginning to flow from the inductor 6 toward the low-side switching transistors (31, 32), control to turn off the low-side switching transistors (31, 32) is performed. Thus, at the timing when the low-side switching transistors (31, 32) turn off (the range P enclosed by a dotted line), the voltage V_{LX} on the common connection end 4 becomes a positive voltage. Therefore an overvoltage being applied between the source and drain of the high-side switching transistors (21, 22) due to the voltage V_{LX} on the common connection end 4 becoming a negative voltage can be avoided. Controlling the drive signal PN supplied to the low-side switch 30 to fall can be performed, for example, by forcibly making the drive signal PN fall, apart from control of dead times.

While the inductor current I_{L} is flowing from the inductor 6 toward the switching transistors (21, 22, 31, 32), the voltage V_{LX} on the common connection end 4 does not become a negative voltage in the dead time T2 from when the low-side switch 30 turns off to when the high-side switch turns on. Thus, the dead time T2 can be set longer as already mentioned. By detecting the direction in which the inductor current I_{L} flows, control to adjust the delay time DLY1b of the delay circuit 124 of the dead time producing circuit 12 already described so as to change the dead time T2 can be performed. For example, by the dead time control circuit 40 controlling the number of stages of inverters of the delay circuit 124 to increase, the delay time DLY1b of the delay circuit 124 can be made longer.

### Fourth Embodiment

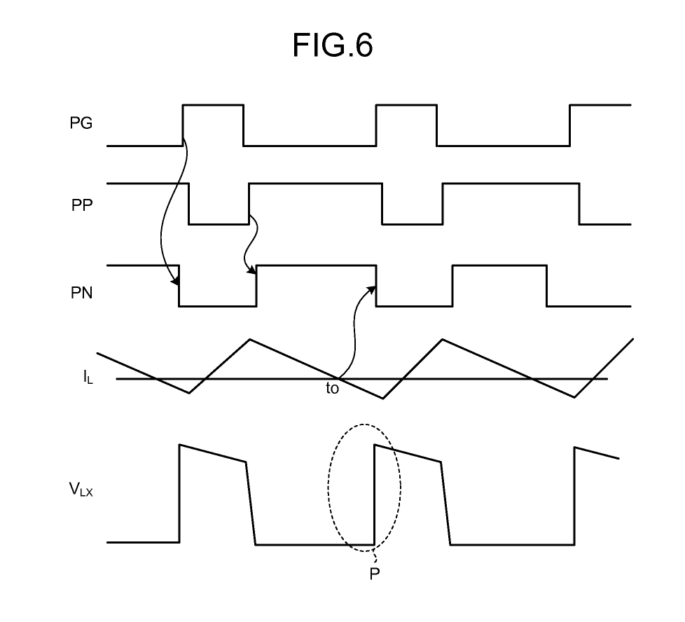

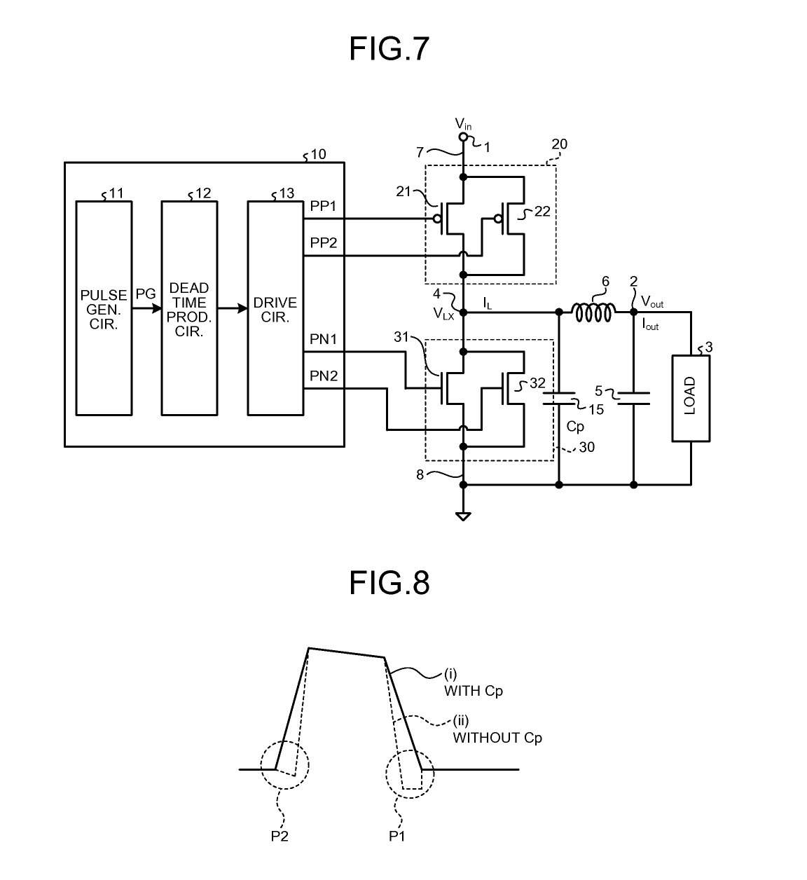

FIG. 7 is a diagram showing the configuration of a power supply circuit of the fourth embodiment. The power supply circuit of this embodiment has a capacitor 15 of which one end is connected to the common connection end 4 and the other end is grounded. That is, the capacitor 15 is connected in parallel with the low-side switch 30.

The control method will be described using FIG. 8. In FIG. 8, a solid line (i) indicates the voltage V_{LX} in the case of comprising the capacitor 15. A dotted line (ii) indicates the voltage V_{LX} in the case where the capacitor 15 does not exist. The gradient of the voltage V_{LX} on the common connection end 4 is determined by the speed at which the inductor current I_{L} charges/discharges the capacitance on the common connection end 4. Thus, by connecting the capacitor 15 to the common connection end 4 to increase the capacitance at the common connection end 4, the gradient of the voltage V_{LX} on the common connection end 4 can be made gradual. For example, if connecting the capacitor 15 to double the capacitance at the common connection end 4, the gradient of the voltage V_{LX} becomes one half.

By making the gradient of the voltage V_{LX} gradual, even where the dead times are set longer, the low-side switching transistors (31, 32) of the low-side switch 30 can be turned on before the voltage V_{LX} on the common connection end 4 becomes a negative voltage. That is, even if the dead time T1 from the timing when the high-side switching transistors (21, 22) of the high-side switch 20 turn off to when the low-side switching transistors (31, 32) of the low-side switch 30 turn on is longer, the voltage V_{LX} becoming a negative voltage in the range indicated by a dotted line P1 corresponding to the dead time T1 can be avoided. Further, by making the gradient of the voltage V_{LX} gradual, with the swing into the negative voltage side of the voltage V_{LX} in the range indicated by a dotted line P2 corresponding to the dead time T2 being small, control to turn on the high-side switch 20 can be performed. Note that by connecting a resistor (not shown) in series to the capacitor 15, the oscillation (ringing) of the voltage occurring on the common connection end 4 when the high-side switch 20 and the low-side switch 30 are turned off, can be attenuated.

By providing the capacitor 15 connected in parallel with the low-side switch 30 to make the gradient of the voltage V_{LX} gradual, even if the dead times are set longer, the voltage V_{LX} becoming a negative voltage, or the voltage V_{LX} swinging much into the negative voltage side can be avoided, and thus an overvoltage being applied to the switching transistors can be avoided.

### Fifth Embodiment

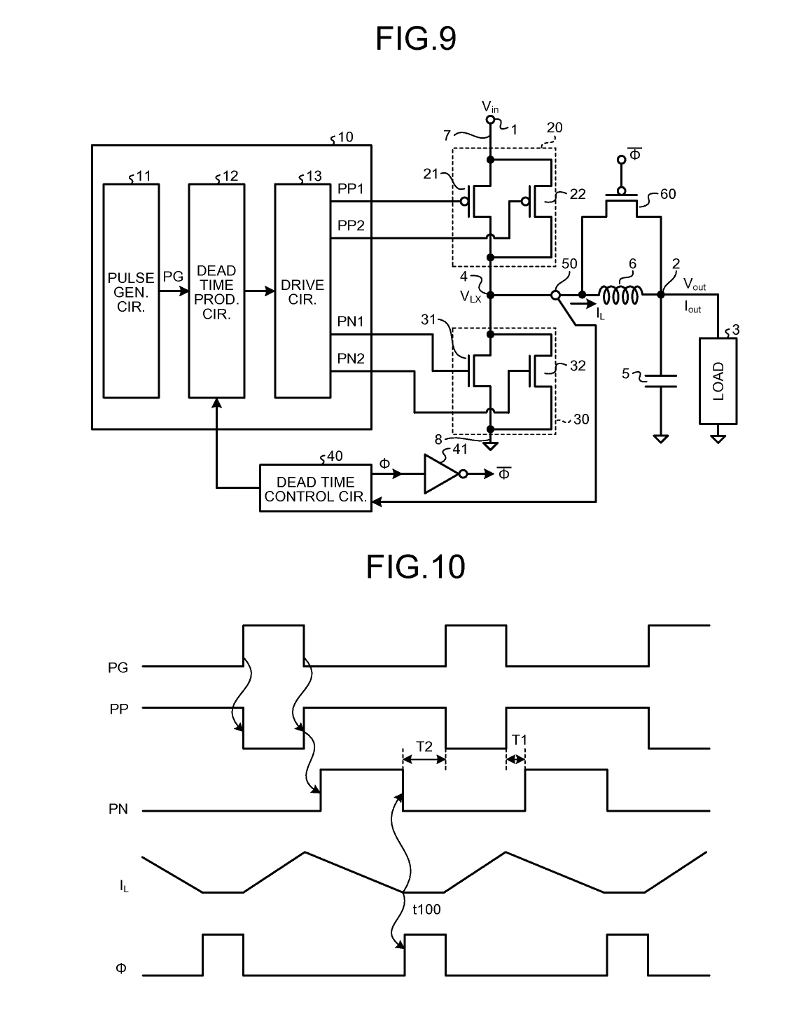

FIG. 9 is a diagram showing the configuration of a power supply circuit of the fifth embodiment. The same reference numerals are used to denote constituents corresponding to those of the already-described embodiments. The power supply circuit of the present embodiment has a current sensor 50. The current sensor 50 can detect the direction in which the inductor current I_{L} flows. For example, the current sensor 50 comprises a resistor (not shown) connected in series to the inductor 6 and can be configured with a voltage comparing circuit (not shown) having the voltage between opposite ends of that resistor inputted thereto. Because the polarity of the voltage inputted to the voltage comparing circuit varies depending on the flow direction of the inductor current I_{L}, the flow direction of the inductor current I_{L} can be detected. By performing control, by the dead time control circuit 40, to adjust the number of stages of inverters of each delay circuit (123, 124, 133, 134) of the dead time producing circuit 12 according to the flow direction of the inductor current I_{L} detected by the current sensor 50 so as to adjust timings when the dead time producing circuit 12 outputs the drive signals (PP1, PP2, PN1, PN2), the dead times can be adjusted.

The output of the current sensor 50 is supplied to the dead time control circuit 40. As described in the already-described embodiments, while the current sensor 50 detects the direction of the current flowing through it, after the inductor current I_{L} begins to flow from the inductor 6 toward the low-side switching transistors (31, 32), the low-side switching transistors (31, 32) are turned off. Thus, the voltage V_{LX} on the common connection end 4 becoming a negative voltage when the low-side switching transistors (31, 32) turn off can be avoided.

The power supply circuit of the present embodiment has a PMOS transistor 60 whose source-to-drain path, its main current path, is connected in parallel with the inductor 6. A control signal φ from the dead time control circuit 40 is inverted by an inverter 41 and supplied to the gate of the PMOS transistor 60.

The control method will be described using FIG. 10. The control signal φ that becomes the high level at a timing t100 when the inductor current I_{L} begins to flow from the inductor 6 toward the low-side switching transistors (31, 32), is outputted from the dead time control circuit 40. The control signal φ is inverted by an inverter 41 and supplied to the gate of the PMOS transistor 60. Thus, the PMOS transistor 60 becomes on, so that the path through which the inductor current I_{L} circulates is formed by the source-to-drain path of the PMOS transistor 60. Hence, the inductor current I_{L} flowing into the common connection end 4 side can be avoided. That is, a negative voltage occurring on the common connection end 4 due to the inductor current I_{L} flowing into the common connection end 4 side can be avoided. For example, in DCM (Discontinuous Conduction Mode) operation, when the high-side switch 20 and the low-side switch 30 are off, so that the inductor current I_{L} cannot be controlled by the switching on/off of the high-side switching transistors (21, 22) and the low-side switching transistors (31, 32), the inductor current I_{L} can be controlled by causing the inductor current I_{L} to circulate through the PMOS transistor 60 connected in parallel with the inductor 6.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply circuit comprising:
a high-side power supply line to which to apply an input voltage;
a common connection end to which one end of an inductive load is connected;
an output end to which the other end of the inductive load is connected;
a low-side power supply line;
a high-side switch having a parallel connection of a plurality of switching transistors whose main current paths are connected between the high-side power supply line and the common connection end;
a low-side switch having a parallel connection of a plurality of switching transistors whose main current paths are connected between the low-side power supply line and the common connection end; and
a control circuit that causes the high-side switch and the low-side switch to alternately turn on/off,
wherein the control circuit controls on/off timings of the plurality of switching transistors forming the high-side switch and the plurality of switching transistors forming the low-side switch individually.

2. The power supply circuit according to claim 1, wherein the switching transistors of the high-side switch are PMOS transistors, and the switching transistors of the low-side switch are NMOS transistors.

3. The power supply circuit according to claim 1, wherein a time from when the low-side switch turns off until the high-side switch is turned on is shorter than a time from when the high-side switch turns off until the low-side switch is turned on.

4. The power supply circuit according to claim 1, comprising a shunt transistor whose main current path is connected between one end of the inductive load and the other end of the inductive load,
wherein the control circuit causes the shunt transistor to turn on at the timing when the low-side switch turns off.

5. The power supply circuit according to claim 1, comprising a capacitor connected in parallel with the low-side switch.

6. The power supply circuit according to claim 1, wherein the high-side switch has first and second switching transistors, and the control circuit has a dead time producing circuit that generates drive signals to turn on the first and second switching transistors at different timings.

7. The power supply circuit according to claim 6, wherein the dead time producing circuit supplies the drive signal to a switching transistor of a smaller size among the first and second switching transistors earlier than to the other.

8. The power supply circuit according to claim 1, wherein the low-side switch has third and fourth switching transistors, and the control circuit has a dead time producing circuit that generates drive signals to turn on the third and fourth switching transistors at different timings.

9. The power supply circuit according to claim 8, wherein the dead time producing circuit supplies the drive signal to a switching transistor of a smaller size among the third and fourth switching transistors earlier than to the other.

10. The power supply circuit according to claim 8, comprising a current sensor that detects the direction of a current flowing through the inductive load, and a dead time control circuit that adjusts timings at which the dead time producing circuit generates the drive signals in response to an output signal from the current sensor.

11. The power supply circuit according to claim 8, comprising a dead time control circuit that adjusts timings at which the dead time producing circuit generates the drive signals, correspondingly to the voltage on the common connection end at the timing when the low-side switch turns off.

12. A power supply circuit comprising:
a high-side power supply line to which to apply an input voltage;
a common connection end to which one end of an inductive load is connected;
an output end to which the other end of the inductive load is connected;
a low-side power supply line;
a high-side switch whose main current path is connected between the high-side power supply line and the common connection end;
a low-side switch whose main current path is connected between the low-side power supply line and the common connection end; and
a control circuit that alternately renders the high-side switch and the low-side switch conductive,
wherein the control circuit performs control to make a first time from when the high-side switch turns off until the low-side switch turns on and a second time from when the low-side switch turns off until the high-side switch turns on be different.

13. The power supply circuit according to claim 12, wherein the first time is set longer than the second time.

14. The power supply circuit according to claim 12, wherein the high-side switch is constituted by a plurality of PMOS transistors connected in parallel, and the low-side switch is constituted by a plurality of NMOS transistors connected in parallel.

15. The power supply circuit according to claim 12, wherein the high-side switch is constituted by a plurality of PMOS transistors connected in parallel and different in size, and the low-side switch is constituted by a plurality of NMOS transistors connected in parallel and different in size.

16. The power supply circuit according to claim 12, comprising a capacitor connected in parallel with the low-side switch.

17. A control method of a power supply circuit which has:
a high-side power supply line;
a common connection end to which one end of an inductive load is connected;
an output end to which the other end of the inductive load is connected;
a low-side power supply line;
a high-side switch having a parallel circuit of first and second switching transistors different in size whose main current paths are connected between the high-side power supply line and the common connection end;
a low-side switch having a parallel circuit of third and fourth switching transistors different in size whose main current paths are connected between the low-side power supply line and the common connection end; and
a drive circuit that outputs drive signals to drive the switching transistors of the high-side switch and drive signals to drive the switching transistors of the low-side switch, the method comprising:
supplying a drive signal outputted earlier than the other among drive signals outputted from the drive circuit to turn on the switching transistors forming the high-side switch to a switching transistor of a smaller size among the switching transistors forming the high-side switch; and
supplying a drive signal outputted earlier than the other among drive signals outputted from the drive circuit to turn on the switching transistors forming the low-side switch to a switching transistor of a smaller size among the switching transistors forming the low-side switch.

18. The control method of the power supply circuit according to claim 17, further comprising
detecting the direction of a current flowing through the inductive load to adjust timings at which to output the drive signals.

19. The control method of the power supply circuit according to claim 17, further comprising
adjusting timings at which to output the drive signals, correspondingly to the voltage on the common connection end when the low-side switch turns off.

20. The control method of the power supply circuit according to claim 17, wherein
the power supply circuit comprises a shunt transistor whose main current path is connected between one end of the inductive load and the other end of the inductive load, and
the control method further comprises turning on the shunt transistor at the timing when the low-side switch turns off.
